(19) United States
(12) Patent Application Publication
(10) Pub. No.: US 2021/0010214 A1
(43) Pub. Date: Jan. 14, 2021

(54) A METHOD AND APPARATUS FOR LAYING PAINT INDICIA ON A ROAD SURFACE AND A METHOD FOR TRANSMITTING INFORMATION TO VEHICLES

(71) Applicant: AUTONOTECH PTE LTD, Singapore (SG)

(72) Inventor: Ian William BELL, Singapore (SG)

(73) Assignee: AUTONOTECH PTE LTD, Singapore (SG)

(21) Appl. No.: 16/977,242

(22) PCT Filed: Mar. 1, 2018
(86) PCT No.: PCT/SG2018/050095

§ 371 Date: Sep. 1, 2020

(51) Int. Cl. E01F 9/518; C09D 5/23; G01V 3/165; G08G 1/0967; G06K 9/00

(52) U.S. Cl. CPC E01F 9/518; C09D 5/23; G06K 9/00798; G08G 1/096716; G01V 3/165

(57) ABSTRACT

The present invention provides a method and apparatus for laying paint indicia on a road surface, whereby the paint indicia includes magnetic elements that can be detected by at least one sensor to provide binary signals for transmission of information to a vehicle communicatively coupled to the at least one sensor. The transmission of information can be carried out regardless of a speed of the vehicle. Furthermore, the transmission of information can be carried out under all weather/visibility/road conditions.

### FIELD OF INVENTION

The present invention relates to the field of autonomous vehicles.

### BACKGROUND

Improvements in automotive technology have led to motor vehicles which are increasingly intelligent. For instance, there are already motor vehicles which are fully autonomous, and used on existing road infrastructure. However, accidents involving such fully autonomous vehicles occur regularly, and as such, the receptiveness to such fully autonomous vehicles by the general public is still lukewarm.

A key impediment for traditional autonomous vehicles is how the vehicle processes unusual circumstances. An example of this is when the autonomous vehicle traverses along a new stretch of road, or a road that is undergoing changes. In traditional autonomous vehicle theory, the vehicle is expected to process this new development through the use of GPS, and other ‘visual’ systems, before processing the newly acquired data, and making decisions based on that. This process is flawed, as depicted in several accidents involving autonomous vehicles. Furthermore, it is noted that some of the shortcomings may be resultant from the GPS infrastructure not being able to cope with large scale use beyond the military applications that it was intended for from its initial conception.

Magnetism has been used in the field of autonomous vehicles for many years, and substantial research has been carried out in this regard. Magnets are either embedded in a road surface, or placed on the road surface itself, both on the edge of the road, and in the middle of the road, from whence they emit a magnetic field which, in turn, is detected by magnetic sensors installed on the underside of vehicles. These sensor modules typically convey over 500 readings per second. This results in the vehicle understanding which lane it must stay in by determining which set of road magnets it must travel between, while similarly understanding the limits and boundaries of the road itself. Magnets on other vehicles also interact with one another to create a ‘safe’ zone of travel.

The types of magnets used are, for instance, ceramic magnetic markers, neodymium magnets, ferrite magnets and so forth. Neodymium magnets are substantially more expensive than the ceramic markers, but are far more powerful. Ferrite magnets are currently perceived as being the most cost-efficient and advantageous.

Magnetization is accepted as a reliable and largely failsafe way to keep an autonomous vehicle both in its lane, and on the road, while additionally being beneficial to traffic patterns by offering the potential of creating far narrower lanes on which vehicles can travel in so-called ‘platoons’.

There are, however, challenges to magnetization, particularly the cost associated with infrastructure implementation. Currently, it would be challenging to retro-fit magnetic features into existing road infrastructure without substantial downtime of the affected portion of the road network.

If magnetic elements are not incorporated into the existing road infrastructure, it is highly likely that the feasibility of autonomous vehicles will be compromised and correspondingly, the adoption of autonomous vehicles will be adversely affected.

### SUMMARY

In a first aspect, there is provided a method for transmitting information to vehicles, the method including:
detecting, with a magnetic flux detector, magnetic flux readings from road markings;
determining, with a processor on the vehicle, at least one binary signal from the magnetic flux readings; and
providing, with the processor, instructions to the vehicle pursuant to the determined binary signal.

In a second aspect, there is provided a vehicle for receiving information from a road surface, the vehicle including a magnetic flux detector and a processor. The vehicle is configured to:
detect, with the magnetic flux detector, magnetic flux readings from road markings;
determine, with the processor, at least one binary signal from the magnetic flux readings; and
provide, with the processor, instructions to the vehicle pursuant to the determined binary signal.

In a third aspect, there is provided a method for laying paint indicia on a road surface, the method including:
laying a base coat of paint;
allowing the base coat of paint to dry to bind the base coat to the road surface;
selecting a pre-defined binary signal for transmission from the paint indicia; and
applying a plurality of magnetic particles within the base coat of paint, the magnetic particles being applied in accordance with the pre-defined binary signal.

In a fourth aspect, there is provided a method for laying paint indicia on a road surface using a plurality of receptacles each containing both paint and magnetic particles, the method including:
emptying each receptacle in a pre-determined sequence,
wherein the magnetic particles in each receptacle are aligned using an electromagnet after each receptacle is emptied.

In a fifth aspect, there is provided an apparatus for laying paint indicia on a road surface, the apparatus comprising:
a paint outlet for egress of paint, the paint including a plurality of magnetic particles; and
a magnetic force generator for aligning the magnetic particles at the paint outlet in a manner where a desired binary signal is transmittable.

It will be appreciated that the broad forms of the invention and their respective features can be used in conjunction, interchangeably and/or independently, and reference to separate broad forms is not intended to be limiting.

### DESCRIPTION OF FIGURES

Some embodiments of the present invention are hereinafter described, by way of example only, with reference to the accompanying drawings, wherein:

FIG. 1 shows an embodiment of the present invention during deployment;

FIG. 2 shows a close up of a sensor depicted in FIG. 1;

FIG. 3 shows a process flow of an embodiment of a method for laying paint indicia on a road surface;

FIG. 4 shows a perspective view of an embodiment of an apparatus used in the method of

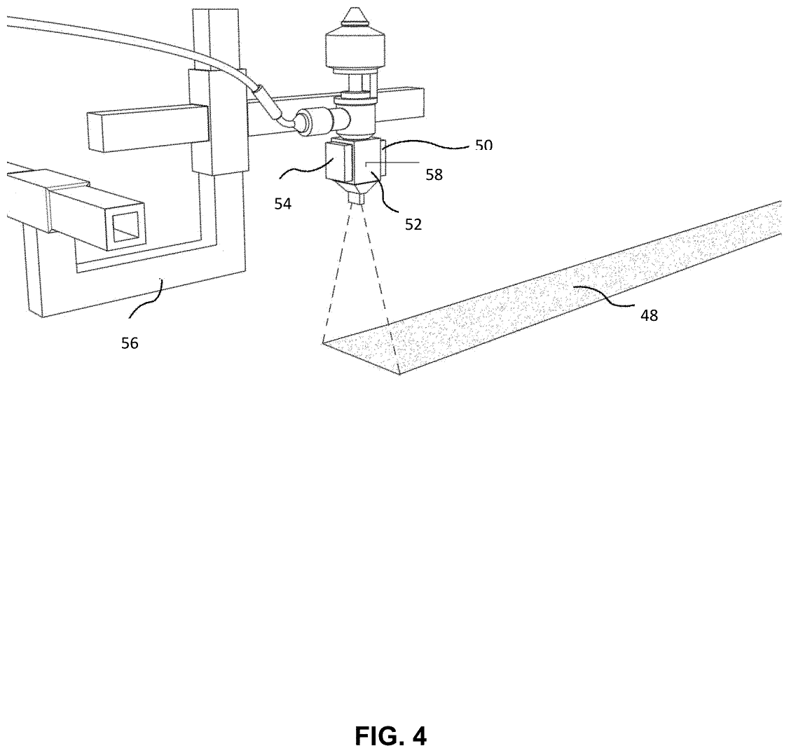

FIG. 3; and

FIG. 5 shows a process flow of an embodiment of a method for transmitting information to vehicles.

### DETAILED DESCRIPTION

The present invention provides a method and apparatus for laying paint indicia on a road surface, whereby the paint indicia includes magnetic elements that can be detected by at least one sensor to provide binary signals for transmission of information to a vehicle communicatively coupled to the at least one sensor. The transmission of information can be carried out regardless of a speed of the vehicle. Furthermore, the transmission of information can be carried out under all weather/visibility/road conditions.

An pexample of a method for laying paint indicia on a road surface will now be described with reference to FIG. 3. It is noted that information can only be transmitted to a vehicle when appropriate paint indicia is laid on a road surface. An apparatus to carry out the method will be described in greater detail in a later portion, but it should be appreciated that the method can be carried out using other apparatus or even multiple apparatus.

At step 200, a base coat of paint is laid on a road surface. The paint used for the base coat can be doped with magnetic particles, whereby the paint is suitable for use on the road surface. At step 205, the base coat of paint is allowed to dry so as to allow the base coat of paint to bind to the road surface, such that the paint indicia is able to remain in a desired position during high traffic usage of the road surface and even if cracks develop along the road surface. However, the base coat of paint could be semi-hardened by the end of the first pre-determined period.

Subsequently, at step 210, a pre-defined binary signal for desired transmission from the paint indicia is selected. For example:
binary signal 1 is selected when information to travel straight is desired to be provided to the vehicle;
binary signal 2 is selected when information to slow down is desired to be provided to the vehicle; and
binary signal 3 is selected when information to stop is desired to be provided to the vehicle, and so forth.

It should be noted that each binary signal can be any combination of “1” and “0”. For example, a “1” reading can occur when a north polarity is detected, while a “0” reading can occur when a south polarity is detected. Of course, the converse can also be a possible embodiment.

In one embodiment, a series of lines/strips on the road can be used to transmit each binary signal. For example, if a series of eight lines/strips is used, it then becomes possible to transmit 256 different types of binary signals. This is so because each line/strip can provide either a “1” or a “0” reading. In order to cater for different vehicular speeds, the width of the lines/strips can be varied. For example, thicker lines/strips can be used for roads with higher speed limits, while thinner lines/strips can be used for roads with lower speed limits. It is also possible that more lines/strips are used for roads with higher speed limits.

In some embodiments, the lines/strips can be located within markers, whereby the markers can be lines/strips which do not have a polarity. Thus, when the markers are detected by a vehicle, the vehicle then starts to read the binary signal conveyed by the series of lines/strips.

In some embodiments where the vehicle travels at high speeds like on highways and autobahns, simplified signals (for example, just a single magnetic polarity) demarcated with the markers are used such that the magnetic flux detector on the vehicle is able to determine a start and an end of each binary signal at speed. It is possible to use simplified signals on highways and autobahns as there are less available options (typically only go straight or filter left/right) compared to city driving.

It should also be noted that each binary signal can be associated with particular information, and the user can select the particular information rather than a type of binary signal during the selection process. These binary signals can define road boundaries and lane limits on the road. Furthermore, they transmit crucial information to the vehicle, enabling defined and determinative action on the part of the vehicle.

At step 215, a plurality of magnetic particles are applied within the semi-hardened base coat of paint, the magnetic particles being applied in accordance with the selected binary signal. Specifically, the placement of the plurality of magnetic particles is in a configuration which provides the pre-defined binary signal for a vehicle with a magnetic reader traversing over the paint indicia. The plurality of magnetic particles are placed within the base coat of paint in a fixed configuration so that the selected binary signal being transmitted is permanent. Once the plurality of magnetic particles are placed within the base coat of paint, the base coat is then allowed to harden at step 220.

The placement of the plurality of magnetic particles can be carried out using an apparatus with a paint outlet and an electromagnet, whereby the electromagnet is activated to align the magnetic particles in a manner where the desired binary signal is transmittable to the vehicle with a magnetic reader traversing over the paint indicia on the road surface. Further details of an embodiment of the apparatus will be provided in a later portion.

Finally, at step 225, a secondary coat of paint is laid onto the base coat of paint. The secondary coat of paint can be different from the base coat of paint. For example, the secondary coat of paint can have light reflective properties or can be hard-wearing such that heavy traffic would not degrade the secondary coat of paint.

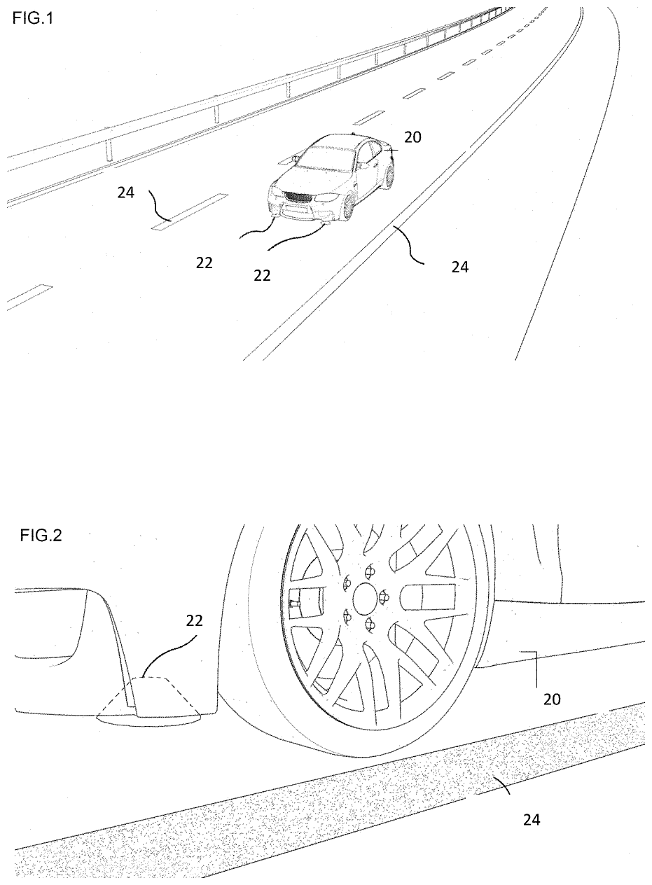

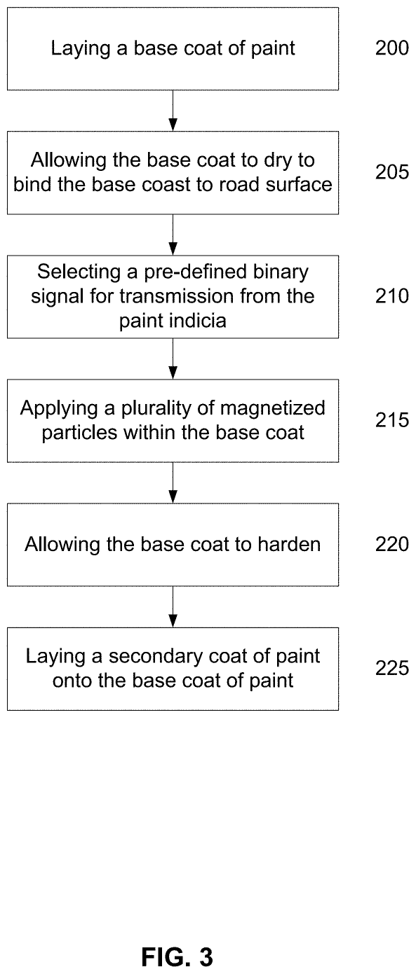

The method that has been described lays paint indicia on road surfaces. The paint indicia is configured to function in a manner as shown in FIGS. 1 and 2. Vehicle 20 is equipped with magnetic sensors which will be given information (binary signals) by detecting the flux density of the magnetic particles in the paint indicia 24. This results in, for example,

1. A vehicle that remains within its lane; and

2. A vehicle that is immediately instructed of what it is expected to do in any given situation (such as stopping at a stop street, slowing for pedestrian crossing, maintaining a newly determined speed through a work zone, etc.).

It should also be noted that determining each binary signal is dependent on accurate detection of flux density and the binary signal can be determined by a processor on the vehicle. For example, the binary signal can be determined from a look-up table. In this regard, the flux density can be made more pronounced by using more magnetic particles. Furthermore, a magnetic flux detector on the vehicle should be configured to be sufficient sensitive to accurately detect flux density variations.

With use of the method, the vehicle 20 is no longer expected to acquire data through visual means before processing and making key decisions. Instead, the magnetic particles in the paint indicia will provide information to the vehicle 20 on precisely how it must react with appropriate instructions by the processor, and will ensure adherence to pre-defined road conditions.

In this regard, the roads, are no longer passive, but become active providers of critical information to vehicles. The vehicles are provided information, regardless of weather/road conditions, which lane they should travel on, what the boundary of the road is, what is expected of the vehicle on the road and so forth.

An example of a method for transmitting information to vehicles will now be described with reference to FIG. 5. It is noted that information can only be transmitted to a vehicle when appropriate paint indicia is laid on a road surface. Typically, the vehicle should include a magnetic flux detector and a processor. In some instances, the vehicle can include vehicle accessories of a magnetic flux detector and a processor, whereby the accessories are communicatively coupled to a processor of the vehicle.

At step 500, magnetic flux readings from road markings are detected with the magnetic flux detector. The road markings can be formed by magnetized paint indicia, provided in a similar manner as described in preceding paragraphs. The magnetized paint indicia can be in a form of a series of lines/strips.

At step 505, at least one binary signal from the magnetic flux readings is determined by the processor. It should be noted that each binary signal can be any combination of “1” and “0”. For example, a “1” reading can occur when a north polarity is detected, while a “0” reading can occur when a south polarity is detected. Of course, the converse can also be a possible embodiment.

In one embodiment, a series of lines/strips on the road can be used to transmit each binary signal. For example, if a series of eight lines/strips is used, it then becomes possible to transmit 256 different types of binary signals. This is so because each line/strip can provide either a “1” or a “0” reading. In order to cater for different vehicular speeds, the width of the lines/strips can be varied. For example, thicker lines/strips can be used for roads with higher speed limits, while thinner lines/strips can be used for roads with lower speed limits. It is also possible that more lines/strips are used for roads with higher speed limits. In some embodiments, the lines/strips can be located within markers, whereby the markers can be lines/strips which do not have a polarity. Thus, when the markers are detected by a vehicle, the vehicle then starts to read the binary signal conveyed by the series of lines/strips.

In some embodiments where the vehicle travels at high speeds like on highways and autobahns, simplified signals (for example, just a single magnetic polarity) demarcated with the markers are used such that the magnetic flux detector on the vehicle is able to determine a start and an end of each binary signal at speed. It is possible to use simplified signals on highways and autobahns as there are less available options (typically only go straight or filter left/right) compared to city driving.

It should also be noted that each binary signal can be associated with particular information, and the user can select the particular information rather than a type of binary signal during the selection process. These binary signals can define road boundaries and lane limits on the road. Furthermore, they transmit crucial information to the vehicle, enabling defined and determinative action on the part of the vehicle.

Finally, at step 510, instructions pursuant to the determined binary signal are provided to the vehicle by the processor. The at least one binary signal can be determined from a look-up up table. The instructions can result in, for example,

1. A vehicle that remains within its lane; and

2. A vehicle that is immediately instructed of what it is expected to do in any given situation (such as stopping at a stop street, slowing for pedestrian crossing, maintaining a newly determined speed through a work zone, etc.).

The present invention provides a solution to magnetization of both existing and new roads, whereby the downtime of existing roads when introducing the magnetization is not substantial, as it can be merely the painting over of existing road markings. Subsequently, the magnetized paint indicia are not susceptible to poor lighting conditions, bad weather, obstructions, and so forth. The present invention provides a reliable road system that, for instance, allows speed limits to be adhered to by reading ‘slow down’-specific magnetized markings, or pedestrian zones to be identified from ‘pedestrian-only’-specific markings.

In some embodiments, the method for laying paint indicia can be simplified. Only a single pass is carried out. A plurality of receptacles each containing both paint and magnetic particles is used, and the laying of the contents of each receptacle represents either “1” or “0” when the magnetized particles in each receptacle are aligned using an electromagnet. Thus the single pass method can generally be viewed as laying a binary signal with a single pass by emptying appropriate receptacles at appropriate positions on a road.

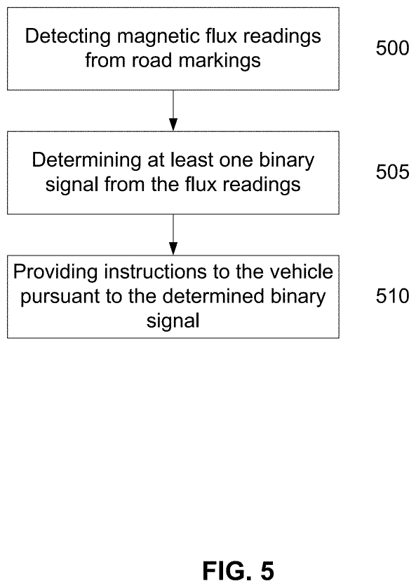

In another aspect, with reference to FIG. 4, there is shown an apparatus 50 for laying paint indicia 48 on a road surface. The apparatus 50 can be used for the method as described earlier.

The apparatus 50 comprises a paint outlet 52 for egress of paint, the paint including a plurality of magnetic particles. The apparatus includes a magnetic force generator 54, typically an electromagnet, for aligning the magnetic particles at the paint outlet 52 in a manner where a desired binary signal is transmittable. There is also a controller 58 for activating the magnetic force generator 54, and for operating the paint outlet 52. By activating the magnetic force generator 54 and operating the paint outlet 52, the controller 58 is able to control how the magnetic particles in the paint are laid in the paint indicia 48, specifically in a manner where the desired binary signal is transmittable from the paint indicia 48.

The apparatus can also include a mount 56 for securing the apparatus 50 to a vehicle that lays the paint indicia on roads. As mentioned earlier, the apparatus 50 enables the earlier mentioned method to be carried out, and as it will be appreciated, retrofitting vehicles to mount the apparatus 50 will not be difficult.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope of the invention.

1. (canceled)

2. (canceled)

3. (canceled)

4. (canceled)

5. (canceled)

6. (canceled)

7. A method for laying paint indicia on a road surface, the method including:
laying a base coat of paint;
allowing the base coat of paint to dry to bind the base coat to the road surface;
selecting a pre-defined binary signal for transmission from the paint indicia; and
applying a plurality of magnetic particles within to the base coat of paint, the magnetic particles being applied in accordance with the pre-defined binary signal.

8. The method of claim 7, further including laying a secondary coat of paint onto the 5 base coat.

9. The method of either claim 7, wherein the plurality of magnetic particles is placed within the base coat of paint to transmit the pre-defined binary signal.

10. The method of any of claims 7, wherein the placement of the plurality of magnetic particles is carried out using an apparatus with a paint outlet and an electromagnet, the electromagnet being activated to align the magnetic particles in a manner where desired the pre-defined binary signal is transmittable.

11. A method for laying paint indicia on a road surface using a plurality of receptacles each containing both paint and magnetic particles, the method including: emptying each receptacle in a pre-determined sequence, wherein the magnetic particles in each receptacle are aligned using an electromagnet after each receptacle is emptied.

12. An apparatus for laying paint indicia on a road surface, the apparatus comprising:
a paint outlet for egress of paint, the paint including a plurality of magnetic particles; and
a magnetic force generator for aligning the magnetic particles at the paint outlet in a 25 manner where a desired pre-defined binary signal is transmittable.

13. The apparatus of claim 12, wherein the magnetic force generator is an electromagnet.

14. The apparatus of claim 12, further comprising a controller for activating the magnetic force generator, and for operating the paint outlet.

15. The method of claim 7, wherein applying the plurality of magnetic particles comprises applying the magnetic particles within markers.

16. The method of claim 15, wherein the markers comprise lines or strips without a 5 polarity.

17. The method of claim 15, wherein the markers demarcate a start of the pre-defined binary signal.

18. The method of claim 15, wherein the markers demarcate an end of the pre-defined binary signal.

19. The method of claim 7, wherein the pre-defined binary signal is configurable to provide to a vehicle, information;
to travel straight; and/or
to slow down; and/or
to stop; and/or
to define road boundaries.

20. The method of claim 11, wherein applying the plurality of magnetic particles comprises applying the magnetic particles within markers.

21. The method of claim 20, wherein the markers comprise lines or strips without a polarity.

22. The method of claim 20, wherein the markers demarcate a start of the pre-defined binary signal.

23. The method of claim 20, wherein the markers demarcate an end of the pre-defined 30 binary signal.

24. The method of claim 11, wherein the pre-defined binary signal is configurable to provide to a vehicle, information;
to travel straight; and/or
to slow down; and/or
to stop; and/or to define road boundaries.
